(19) United States
(12) Patent Application Publication
(10) Pub. No.: US 2010/0185617 A1
(43) Pub. Date: Jul. 22, 2010

(54) CONTENT AUGMENTATION FOR PERSONAL RECORDINGS

(75) Inventors: Dzevdet Burazerovic, Eindhoven (NL); Pedro Fonseca, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,586

(22) PCT Filed: Aug. 9, 2007
(86) PCT No.: PCT/IB07/53168

§ 371 Date: Feb. 6, 2009

(30) Foreign Application Priority Data
Aug. 11, 2006 (EP) 06300876.7

(51) Int. Cl. G06F 17/30

(52) U.S. Cl. 707/736; 707/E17.044; 707/769; 707/E17.014

(57) ABSTRACT

A content augmentation process for personal recordings involves a service center (SC). The service center (SC) collects personal recordings from various different users via a network so as to constitute a database (DB) of personal recordings. The service center (SC) identifies personal recordings within the database (DB) that concern a particular scene and that are mutually complementary so as to form a selection of personal recordings (FSRR) for content augmentation purposes. The service center (SC) applies a content augmentation process (AUGP) to the selection of personal recordings (FSRR) so as to obtain an enhanced representation (CA).

### FIELD OF THE INVENTION

An aspect of the invention relates to a method of content augmentation for personal recordings, such as, for example, photos, videos, and audio recordings. Other aspects of the invention relate to a service center for personal recordings, and a computer program product for a programmable processor.

### BACKGROUND ART

Content augmentation is a process in which an enhanced representation of a scene is established on the basis of various different representations of that scene. The scene may be, for example, a tourist site, a sporting event, a concert, a conference, an exhibition, a wedding, etc. A representation of a scene is typically in the form of a recording, such as, for example, a photo, a video, or an audio recording, whichever is appropriate. A representation of a scene comprises certain information about the scene. Another representation of the scene, which has been established somewhat differently, may comprise complementary information. Content augmentation uses, as it were, mutually complementary information, which is comprised in various different representations of a scene, in order to establish an enhanced representation.

There are numerous different content augmentation strategies and techniques. For example, a three-dimensional model of an object may be build on the basis of a relatively great number of complementary two-dimensional images that represent the same object from different perspectives. A so-called two-and-one-half dimensional model, which adds depth information to a two-dimensional image of the object, may be build on the basis of a few images that show the object from a few different angles. Building such a model is similar to the manner in which the human brain creates perception of depth on the basis of information coming from the left and the right eye, respectively.

As another example, content augmentation may also suppress noise in a particular representation on the basis of complementary information that other representations provide. This particularly applies to audio recordings. Another example of content augmentation that concerns audio recordings is separating distinct audio sources from each other. This technique is often referred to as blind source separation. Yet another example of audio content augmentation is localizing a particular speaker for the purpose of speech recognition. Still another example of audio content augmentation is creating surround sound effects, or creating virtual acoustic images for multiple listeners.

U.S. Pat. No. 6,898,637 discloses an Internet based music collaboration system in which musicians and/or vocalists at client locations transmit audio signals to a server location. At this location, the audio signals are combined into a composite musical work and sent back to each of the client locations. The work may be sent back as a composite musical signal, which is the concatenation of all individual audio signals, or as a mix of audio signals.

### SUMMARY OF THE INVENTION

It is an object of the invention to allow user-friendly content augmentation of personal recordings. The independent claims define various aspects of the invention. The dependent claims define additional features for implementing the invention to advantage.

The invention takes the following points into consideration. A person may obtain augmented content in an autonomous manner by making multiple recordings that concerns a same scene. For example, a person may obtain a three-dimensional model of an object by making numerous photos of that object. Although this may be acceptable to a dedicated professional, it is not much appealing to an average person. The average person may be, for example, a tourist visiting an attraction, a spectator of a sporting event, a concert, or an exhibition, or an invitee of a wedding or another party. The average person will generally prefer spending his or her time on actually enjoying a scene rather than making numerous recordings of the scene.

Consumer devices that allow average persons to make digital recordings of a scene are nowadays quite affordable and, as a result, these devices are widespread. A relatively great number of persons possess a digital camera, a digital camcorder, and a digital audio recorder, or at least one of these devices. These persons generally equally possess some form of communication device that allows communicating digital recordings to relatives and friends. The communication device may be, for example, a personal computer, or a similar device, which is coupled to the Internet via a server. What is more, more and more persons possess a mobile phone that is capable of making digital recordings and of communicating these recordings instantly.

Consequently, there is a relatively high probability that a scene to which relatively many persons assist is digitally recorded by several persons. As a result, there is also a relatively high probability that, for a given recording of such a scene, there are one or more complementary recordings, which are suitable for content augmentation purposes. For example, let it be assumed that the scene is a tourist site, which attracts many visitors. There is a relatively high probability that several persons are making digital photos of the tourist site at a particular instant. Consequently, when a particular tourist makes a digital photo of the tourist site, it is probable that one or more other tourists are making complementary digital photos, which are suitable for content augmentation purposes.

However, respective persons that independently make complementary recordings of a particular scene need not necessarily know each other. Consequently, these persons may never share their respective recordings for the purpose of content augmentation. For example, a spectator who is making a digital photo of a sporting event need not necessarily know all other spectators who are making complementary digital photos of the sporting event. At the best, the spectator may have one or more relatives or friends who are also spectators, some of whom may also make digital photos of the sporting event. As a result, any content augmentation will be based on relatively few digital photos, unless the spectator of interest and his or her relatives or friends devote relatively much time making numerous digital photos while the sporting event takes place. This is not attractive.

In accordance with the invention, a content augmentation process for personal recordings involves a service center, which may be in the form of one or more network servers. The service center collects personal recordings from various different users via a network so as to constitute a database of personal recordings. The service center identifies personal recordings within the database that concern a particular scene and that are mutually complementary so as to form a selection of personal recordings for content augmentation purposes. The service center applies a content augmentation process to the selection of personal recordings so as to obtain an enhanced representation.

Accordingly, a user who wishes to obtain an enhanced representation by means of content augmentation can effectively benefit from numerous personal recordings that many other users have made. This alleviates the user from the burden of making relatively many personal recordings of a scene, which he or she wishes to enjoy. A user who obtains an enhanced representation from the service center may remain unaware of respective identities of other users whose personal recordings have been used to establish the enhanced representation. There is no need for any initial communication and coordination between users. In this sense, the service center allows an anonymous cooperation between numerous users for the purpose of content augmentation. This cooperation can be very effective because, as considered hereinbefore, there is a relatively high probability that the database within the service center comprises mutually complementary personal recordings of a particular scene.

An implementation of the invention advantageously comprises one or more of following additional features, which are described in separate paragraphs that correspond with individual dependent claims.

The service center preferably associates metadata with a personal recording that is collected. The metadata describes content of the personal recording. In order to form a selection of personal recordings for content augmentation purposes, the service center preferably compares metadata that is associated with a personal recording with metadata that is associated with another personal recording.

The service center preferably generates supplementary metadata on the basis of metadata that is received in association with a personal recording.

In order to generate supplementary metadata, the service center preferably interrogates an auxiliary database on the basis of the metadata received in association with the personal recording.

The service center preferably transmits a query message to a device from which a personal recording has been submitted to the service center. The query message may cause the device to prompt a user of the device to specify metadata. These additional features, as well as those specified in the preceding three paragraphs, contribute to an efficient and robust content augmentation process, either independently, or in combination.

The service center preferably manages respective collections of personal recordings, each of which belongs to a particular user. The respective collections of personal recordings are stored in the database. The selection step involves various collections belonging to various different users. These additional features allow a so-called one-stop shopping for reliable high-capacity storage of personal recordings as well as content augmentation services.

A detailed description with reference to drawings illustrates the invention summarized hereinbefore, as well as the additional features.

### BRIEF DESCRIPTION OF THE DRAWINGS

FIG. 1 is a conceptual diagram that illustrates an infrastructure for content augmentation.

FIG. 2 is a functional diagram that illustrates a service center for personal recordings, which forms part of the infrastructure for content augmentation.

FIG. 3A is a flow chart diagram that illustrates a series of steps that the service center carries out so as to process and store a personal recording, which a user has submitted to the service center.

FIG. 3B is a flow chart diagram that illustrates a further series of steps that the service center carries out so as to generate a content-augmented version of the personal recording, which the user has submitted.

### DETAILED DESCRIPTION

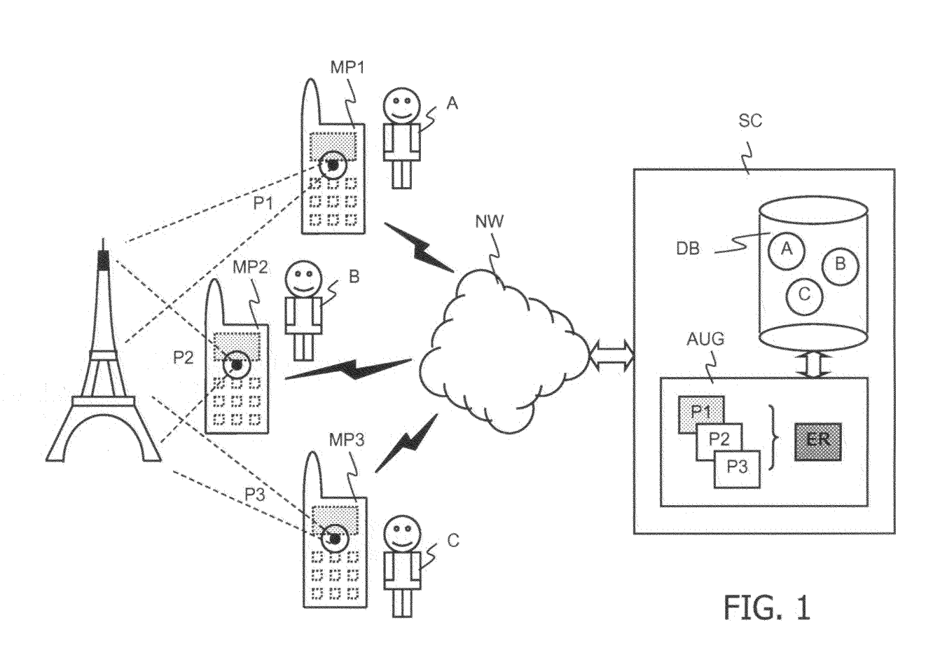

FIG. 1 illustrates an infrastructure that allows users to benefit from a collaborative content augmentation service. The infrastructure comprises a service center for personal recordings SC and a network NW. The service center for personal recordings SC is in the form of a network server, which may co-operate with one or more other network servers. The service center for personal recordings will simply be referred to as service center SC hereinafter. Various mobile phones can communicate with the service center SC via the network NW. FIG. 1 illustrates three mobile phones MP1, MP2, MP3, which belong to users A, B, and C, respectively.

The three mobile phones MP1, MP2, MP3 are each equipped with a camera. This allows users A, B, and C to take a photo or to shoot a video, or both. A mobile phone typically comprises a microphone and may therefore also be used as a sound recorder. That is, each user A, B, and C can use his or her mobile phone, respectively, to make personal recordings. A personal recording may thus comprise audio information or visual information, which may be in the form of a photo or a video, or any combination of such information.

The service center SC comprises a database DB and a content augmentation facility AUG. A user may upload a personal recording into the database DB of the service center SC. In order to do so, the user may need to subscribe to the service center SC. The service center may operate on a “pay-per-use” basis that involves, for example, a prepaid card on which a credit to stored. The credit may be reduced by a given amount when the user uploads a personal recording. Alternatively, uploading personal recordings may be free of charge. In any case, the database DB stores personal recordings of many different users, including personal recordings of user A, user B, and user C.

The service center SC may keep a collection of personal recordings that belong to user A, another collection of recordings that belong to user B, and yet another collection of recordings that belong to user C. Accordingly, each user may access and manage his or her collection of personal recordings in the database DB as if the collection were present on a hard disk within his or her mobile phone. That is, the service center SC may act as a high-capacity storage device, which protects against data loss.

The content augmentation facility AUG can generate an enhanced representation on the basis of various personal recordings from different users. An enhanced representation may be, for example, a three-dimensional model of an object, which is generated on the basis of various different photos of that object from different perspectives. As another example, an enhanced representation may be a surround-sound representation of a musical event, which is generated on the basis of various different sound recordings made at different locations.

In FIG. 1, users A, B, and C make different photos P1, P2, P3, respectively, of a tourist site. Users A, B, and C transmit these respective photos to the service center SC. Let it be assumed that user A requests an enhanced representation ER of the tourist site. User A may make such a request, for example, while submitting photo P1 to the service center SC. In response, the content augmentation facility AUG combines, as it were, photo P1, which was taken by user A, with photos P2 and P3, which were taken by users B and C, respectively. More precisely, the content augmentation facility AUG generates the enhanced representation ER of the tourist site on the basis of the aforementioned photos. The service center SC may then transmit the enhanced representation ER to user A who made the request. The service center SC may further notify users B and C that an enhanced representation is available so that these users may download the enhanced representation ER if they wish to do so.

In order to generate an enhanced representation, the content augmentation facility AUG needs to identify personal recordings that are mutually complementary. To that end, the content augmentation facility AUG may make use of so-called metadata. Metadata that belongs to a personal recording is data that describes the personal recording. For example, the metadata may indicate the location where the personal recording was made and the time when the personal recording was made. The metadata may also indicate various settings of the device with which the personal recording was made.

For example, the three mobile phones MP1, MP2, MP3 illustrated in FIG. 1 may each comprise a GPS receiver that indicates the location of the mobile phone concerned. The network NW can also provide indications of the respective locations of the three mobile phones MP1, MP2, MP3. The three mobile phones MP1, MP2, MP3 each comprise a clock that indicates the time. Accordingly, mobile phone MP1 may transmit metadata in association with photo P1, which metadata indicates the location where photo P1 was taken and the time when photo was taken. The metadata may also comprise an indication of the identity of user A, who took photo. Such an identity indication may be based on identity information comprised in mobile phone MP1 for the purpose of identification within the network NW. Similarly, the other mobile phones MP2, MP3 may transmit metadata in association with photos P2, P3, respectively.

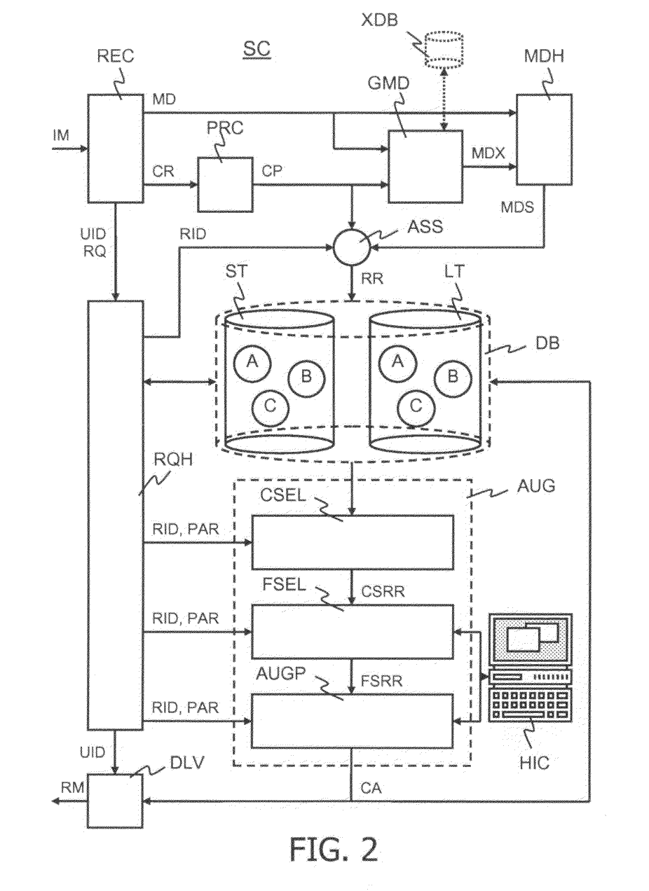

FIG. 2 illustrates details of the service center SC. The database DB may comprise a short-term memory ST and a long-term memory LT. The content augmentation facility AUG comprises the following functional entities: a coarse selection facility CSEL, a fine selection facility FSEL, and a content augmentation processor AUGP. The fine selection facility FSEL and the content augmentation processor AUGP may interact with a human intervention console HIC.

The service center SC comprises various functional entities in addition to the database DB and content augmentation facility AUG illustrated in FIG. 1. These functional entities include a reception facility REC, a content processor PRC, a metadata generator GMD, a metadata handling facility MDH, and an association facility ASS. These functional entities play a role in preparing a personal recording for storage in the database DB. What is more, these functional entities contribute to a satisfactory operation of the content augmentation facility AUG. To that end, the metadata generator GMD may interact with one or more auxiliary databases XDB, which need not necessarily form part of the service center SC. This will be explained in greater detail hereinafter. The service center SC further comprises the following functional entities: a request handling facility RQH and a delivery facility DLV.

Any of the aforementioned functional entities may be implemented by means of software or hardware, or a combination of software and hardware. For example, each of these functional entities may be implemented by suitably programming a processor. In such a software-based implementation, a software module may cause the processor to carry out specific operations that belong to a particular functional entity. As another example, each of the aforementioned functional entities may be implemented in the form of a dedicated circuit. This is a hardware-based implementation. Hybrid implementations may involve software modules as well as one or more dedicated circuits.

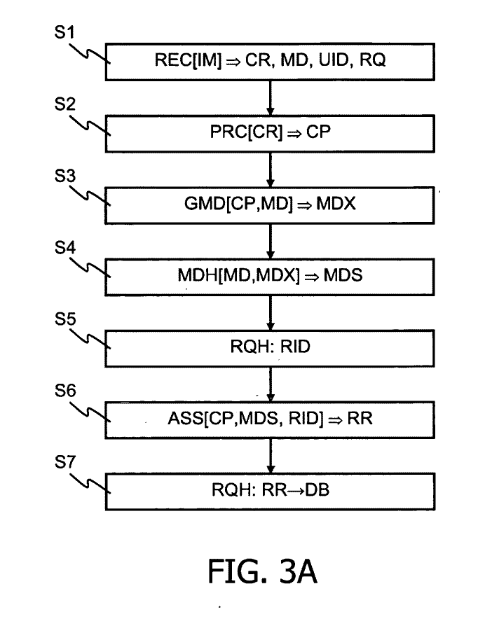

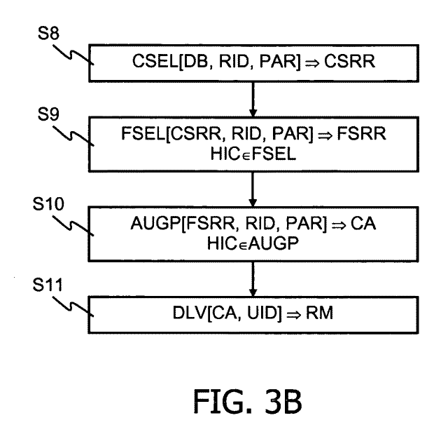

FIG. 3A illustrates the various steps that the service center SC carries out upon reception of an input message IM. The input message IM may originate, for example, from one of the three mobile phones MP1, MP2, MP3, which are illustrated in FIG. 1. The input message IM concerns a personal recording, which a user submits to the service center SC. Consequently, the input message IM comprises recording content CR. In addition, the input message IM may comprise the following elements: metadata MD that belongs to the recording content CR, user identification UID, and a request for service RQ. The request for service RQ may indicate, for example, that the user wishes to add the personal recording to a collection of personal recordings, which belong to the user. In particular, the request of service may indicate that the user wishes to receive a content-augmented version of the personal recording.

In step S1, the reception facility REC syntactically analyzes the input message IM, which has a specific format. In doing so, the reception facility REC separates respective elements that are comprised in the input message IM. For example, the reception facility REC retrieves the recording content CR, the metadata MD that belongs to the recording content CR, the user identification UID, and the request for service RQ. The reception facility REC may further syntactically analyze the metadata MD that is comprised in the input message IM for the purpose of, for example, reformatting the metadata MD. The service center SC may use a specific, uniform metadata format in which all metadata should be cast. The metadata that the reception facility REC extracts from the input message IM will be referred to as received metadata MD hereinafter.

In step S2, the content processor PRC may process the recording content CR for various purposes. For example, the content processor PRC may suppress noise within the recording content CR for the purpose of quality improvement. The content processor PRC may also carry out a signal normalization process for the purpose of uniformity between different personal recordings. Accordingly, the content processor PRC provides processed recording content CP, which is a quality-improved version of the recording content CR. Alternatively, the content processor PRC may effectively be deactivated. In this case, the processed recording content CP corresponds with the recording content CR.

In step S3, the metadata generator GMD may generate supplementary metadata MDX, if so required. The supplementary metadata MDX comprises one or more elements that complement the received metadata MD. The metadata generator GMD may generate supplementary metadata MDX on the basis of the processed recording content CP by carrying out one or more multimedia content analysis algorithms. A multimedia content analysis algorithm typically extracts one on more descriptors from a multimedia content. The descriptors, which describe the multimedia content, may be obtained through, for example, statistical pattern recognition.

The metadata generator GMD may also generate supplementary metadata MDX on the basis of the received metadata MD. The metadata generator GMD may formulate a query that includes one or more elements of the received metadata MD. The metadata generator GMD may submit such a query to a search engine that interrogates the one or more auxiliary databases XDB. The metadata generator GMD may also comprise a search engine, which directly interrogates the one or more auxiliary databases XDB. A query response may potentially comprise one or more elements that constitute supplementary metadata MDX.

The following is an example of generating supplementary metadata on the basis of received metadata. Let it be assumed that the recording content CR concerns a photo of a tourist site in the open air, such as, for example, the Eiffel Tower. Let it further be assumed that the received metadata MD comprises a time indication, which specifies when the photo was taken, and a location indication, which specifies where the photo was taken in the form of geographical coordinates. The metadata generator GMD can interrogate a weather database on the basis of the geographical coordinates and the time, which the location indication and the time indication specify, respectively. Accordingly, the metadata generator GMD can establish weather and lighting conditions under which the photo was taken. In this example, the supplementary metadata MDX, which the metadata generator GMD generates, specify these conditions. Knowledge of weather and lighting conditions, under which the photo was taken, may be particularly useful to the content augmentation facility AUG. The metadata generator GMD may derive further context information from other databases through formulating queries that specify time and location.

The following is another example of generating supplementary metadata on the basis of received metadata. Let it be assumed that the recording content CR concerns a photo that has been taken during a performance in a concert hall. Let it further be assumed that the received metadata MD comprises a location indication and a time indication similar to those mentioned hereinbefore. The metadata generator GMD can use the geographical coordinates, which the location indication specifies, to interrogate a geographical database DB. The geographical database DB can be regarded as a detailed map, which associates man-made structures and natural features with geographical coordinate zones. Accordingly, the metadata generator GMD can establish that the photo was taken within the concert hall.

The metadata generator GMD may further interrogate a concert agenda, which is available on a web site of the concert hall. Accordingly, metadata generator GMD can establish the particular concert that took place when the photo was taken. The metadata generator GMD can further establish names of artists who participated in the performance and who are likely to be present on the photo that was taken. Accordingly, in this example the supplementary metadata MDX, which the metadata generator GMD generates, specifies the following elements: concert hall name, concert name, performing artists, etc. The metadata generator GMD may even cause the service center SC to request the user to provide supplementary metadata. To that end, the service center SC may send a query message to the user. For example, in the case of the aforementioned example, the query message may concern a seat number in the concert hall where the photo was taken. The service center SC may send this query message to, for example, the device with which the photo was taken. This can be done shortly after the user has submitted the recording content CR to the service center SC, so that there is a quick feedback. Upon reception of the query message, the device prompts the user to enter his or her seat number. The device may be arranged to automatically transmit this information to the service center SC, which routes the information about the seat number to the metadata generator GMD.

In step S4, the metadata handling facility MDH combines the received metadata MD and the supplementary metadata MDX, if any, which the metadata generator GMD provides. This combination constitutes service metadata MDS, which the content augmentation facility AUG will use in a manner described hereinafter. The metadata handling facility MDH may parse the received metadata MD and the supplementary metadata MDX so as to certain that there is no inconsistency. The metadata handling facility MDH may also identify one or more elements that are missing and cause the metadata generator GMD to provide these elements. That is, the metadata handling facility MDH ascertains that the service metadata MDS is sufficiently complete and consistent.

In step S5, the request handling facility RQH assigns a record identification RID to the processed recording content CP. The record identification RID uniquely identifies the processed recording content CP within the service center SC. The record identification RID may comprise the user identification UID followed by a serial number.

In step S6, the association facility AS associates various elements with each other: the record identification RID, the processed recording content CP, and the service metadata MDS. These elements constitute a personal recording record RR, which is stored in the database DB.

In step S7, the request handling facility RQH causes the personal recording record RR to be stored in the database DB. More specifically, the personal recording record RR is stored in the short-term memory ST or in the long-term memory LT of the database DB, or in both memories, depending on whether the content augmentation facility AUG is likely to use the processed recording content CP within a relatively short term or not.

For example, let it be assumed that the processed recording content CP concerns a short video of a sporting event that is taking place. The short video, which has just been shot, may concern a particular highlight of the sporting event, such as, for example, a goal in a football match. It may be expected that other users who attend to the sporting event will submit different short videos and photos of the sporting event to the service center SC. It may further be expected that one or more of these users will request a content-augmented version of his or her personal recording, while the sporting event is taking place, or shortly afterwards. Accordingly, the request handling facility RQH will cause personal recording records that concern the sporting event, to be stored in the short-term memory ST. This allows the content augmentation facility AUG to rapidly retrieve various different videos, photos, and other personal recordings that concern the sporting event so as to quickly generate one or more enhanced personal recordings.

The request handling facility RQH may decide to store the personal recording record RR in the short-term memory ST of the database DB or in the long-term memory LT on the basis of, for example, the service metadata MDS. As explained hereinbefore, the service metadata MDS may indicate whether the personal recording record RR concerns a so-called life event, such as a sporting event, a concert, a wedding, or not. In case the personal recording record RR concerns a life event, the request handling facility RQH will generally cause the personal recording to be stored in the short-term memory ST of the database DB.

The request handling facility RQH may decide to systematically store each personal recording record that satisfies the following two criteria in the short-term memory ST. Firstly, the personal recording record comprises content that has recently been recorded. That is, a user has submitted a personal recording to the service center SC shortly after he or she has made the personal recording. Secondly, the request for service RQ, which accompanies the personal recording in the input message IM, indicates that the user wishes to receive a content-augmented version of the personal recording.

FIG. 3B illustrates various steps that the service center SC carries out in case the request for service RQ in the input message IM indicates that the user wishes to receive a content-augmented version of a personal recording. The input message IM may comprise the recording content CR that needs to be augmented, in which case the input message IM is processed as described hereinbefore with reference to FIG. 3A.

Alternatively, the recording content CR may have previously been submitted to the service center SC so that the recording content CR has already been processed as described hereinbefore with reference to FIG. 3A. In that case, the input message IM may merely comprise a reference to the recording content CR that is to be augmented. The record identification RID constitutes the reference that is used within the service center SC as explained hereinbefore. The record identification RID identifies the recording content CR that needs to be augmented, as well as the service metadata MDS that belongs to his content, which are all comprised in a particular personal recording within the database DB.

The request handling facility RQH may derive from the request for service RQ one or more parameters PAR, which the content augmentation facility AUG should take into account. For example, the one or more parameters PAR may indicate that the user wishes to receive a three-dimensional model of an object that he or she has photographed. As another example, the one or more parameters PAR may indicate that the user wishes to receive a panoramic view of the object that he or she has photographed. As yet another example, which concerns a sound recording of a musical event, the one or more parameters PAR may indicate that the user wishes to receive a surround-sound version of the recording that he or she has made. As still another example, the one or more parameters PAR may indicate that the user wishes a noise-free version of the recording that he or she has made. There may be relatively much background noise in the recording, which the user wishes to eliminate.

It should be noted that the aforementioned one or more parameters PAR may be established in an interactive fashion. That is, the user may first simply submit his or her personal recording to the service center SC, while specifying that he or she wishes to receive a content-augmented version without providing specific details. In response, the service center SC may provide a menu message that specifies various content augmentation options that are available. The user may then choose one or more of these options, which choice is communicated to the service center SC. In similar fashion, the service center SC may require the user to specify further details.

In step S8, the coarse selection facility CSEL establishes a coarse selection of personal recording records CSRR on the basis of the record identification RID. As mentioned hereinbefore, the record identification RID identifies the recording content CR, which the user wishes to augment. This recording content CR is comprised in a particular personal recording record RR, which record further comprises the service metadata MDS that belongs to the recording content CR, as explained hereinbefore. The particular personal recording record RR that comprises the recording content CR, which the user wishes to augment, will be referred to as reference personal recording record RR hereinafter.

The coarse selection facility CSEL searches in the database DB for personal recording records that comprise recording content that complements the recording content CR in the reference personal recording record RR. This search is based on service metadata that is comprised in the personal recording records within the database DB. The coarse selection facility CSEL identifies personal recording records of which the service metadata is similar to the service metadata MDS in the reference personal recording record RR. The one or more parameters PAR, which the request handling facility RQH has derived from the request for service RQ, may indicate one or more specific service metadata elements that should be similar. Other metadata elements are effectively ignored in that case. In other cases, the coarse selection facility CSEL takes all metadata elements into account.

For example, let it be assumed that the service metadata MDS in the reference personal recording record RR indicates that the recording content CR in this record concerns a particular performance in a particular concert hall at a particular date. The user wishes to obtain an augmented version of the recording content CR, such as, for example, a three-dimensional representation of the particular performance concerned. In that case, the coarse selection facility CSEL identifies personal recording records that concern the same particular performance in the same particular concert hall at the same particular date.

In general, the coarse selection facility CSEL identifies complementary personal recording records on the basis of relevant service metadata elements. Do the relevant service metadata elements within a personal recording record correspond with the relevant service metadata elements in the reference recording record RR? If so, the recording content in the personal recording record is potentially complementary with the recording content CR that the user wishes to augment. Such complementary recording content is potentially useful for content augmentation in the content augmentation processor AUGP. Accordingly, the coarse selection of personal recordings records CSRR is a collection that comprises the reference personal recording record RR and potentially complementary personal recording records.

In step S9, the fine selection facility FSEL establishes a fine selection of personal recording records FSRR, which is a subset of the coarse selection of personal recording records CSRR. To that end, the fine selection facility FSEL may analyze the recording content of each personal recording record in the coarse selection so as to determine if there is a sufficient match between that recording content and the recording content CR that the user wishes to augment. This analysis may involve identification of so-called feature points in the recording content CR.

The fine selection facility FSEL may comprise a suitably programmed processor that automatically identifies these feature points. This processor may subsequently compare the feature points of the recording content CR that the user wishes to augment with the feature points in each other recording content within the coarse selection of personal recording records CSRR. The processor may automatically retain only those personal recording records of which the recording content CR has sufficiently matching feature points. In case the recording content CR is an image, the fine selection facility FSEL may apply so-called computer vision techniques, which comprise image-matching operations based on feature points. In the case of audio, the fine selection facility FSEL may apply so-called acoustic analysis techniques, which comprise audio-matching operations based on time or frequency domain analysis. In this case, the feature points may take the form of spectral coefficients, pitch coefficients, etc.

The fine selection facility FSEL may allow human intervention via the human intervention console HIC. Human intervention can assist the fine selection facility FSEL in finding sufficiently matching recording content. For example, a person may visually inspect an image and identify one or more initial feature points in the image within a relatively short time. Subsequently, a suitably programmed processor can establish a degree of matching on the basis of these initial feature points and can then decide whether the image should be retained or not. A similar approach can be used in the case of audio recordings. Such a human-assisted automatic selection will generally be less error-prone than a fully automatic selection.

Human intervention may also be useful once a suitably programmed processor has established an initial fine selection of personal recording records. A person can check each recording content in this initial fine selection so as to determine whether the recording content will be useful for content augmentation in the content augmentation processor AUGP, or not. Accordingly, the person establishes the fine selection of personal recording records FSRR by eliminating less useful material in the initial fine selection. The person who carries out the human intervention may also edit one or more personal recording records by, for example, eliminating a part of the recording content. Editing may also involve modifying one or more characteristics of the recording content, such as, for example, adjusting brightness or color of images, or adjusting volume of audio recordings. Editing may also involve further signal processing, such as, for example, noise suppression. Appropriate editing software may facilitate such human intervention.

In step S10, the content augmentation processor AUGP provides a content-augmented representation CA on the basis of the fine selection of personal recording records FSRR. The augmentation processor AUGP takes into account the one or more parameters PAR that the request handling facility RQH has derived from the request for service RQ. A person may also specify one or more content augmentation parameters via the human intervention console HIC.

There are numerous content augmentation strategies and techniques that the content augmentation processor AUGP may apply. For example, let it be assumed that the recording content CR, which is to be augmented, is a two-dimensional image of an object. In that case, the content augmentation processor AUGP may build three-dimensional model on the basis of complementary two-dimensional images that represent the same object from different perspectives. Building a three-dimensional model typically involves matching feature points on the respective two-dimensional images.

As another example, the content augmentation processor AUGP may also build a so-called two-and-one-half dimensional model, which adds depth information to the two-dimensional image of the object. Such a model can be built with relatively few images that show the object from a few different angles, which are slightly different. Building such a model is similar to the manner in which the human brain creates perception of depth on the basis of information coming from the left and the right eye, respectively. The model may be in the form of a so-called depth map that is associated with an image. The depth map allows rendering the image on a special display device that can project different views to an observer so as to create a depth sensation. Such a special device may be, for example, lenticular-based.

As yet another example, let it be assumed that the recording content CR constitutes audio information. Different users at different locations have made different personal recordings of a particular audio scene. The coarse selection facility CSEL and the fine selection facility FSEL have identified these different personal recordings, which are assumed to be present in the database DB. In that case, the fine selection of personal recording records FSRR constitutes a multi-microphone recording of an audio scene. Service metadata within the fine selection of personal recording records FSRR indicate relative microphone locations: the location of a microphone with respect to other microphones.

The content augmentation processor AUGP can apply various strategies and techniques depending on a desired result. For example, the content augmentation processor AUGP can suppress background noise, localize a particular speaker for the purpose of speech recognition, or separate distinct audio sources from each other. The last mentioned technique is often referred to as blind source separation. As further examples, the content augmentation processor AUGP can create surround sound in effects, or can even create virtual acoustic images for multiple listeners. All these examples involve localization and separation of acoustic sources. Accordingly, knowledge of the relative microphone locations, which is comprised in service metadata, is useful to the content augmentation processor AUGP.

In step S11, the delivery facility DLV sends a return message RM to the user from whom the input message IM with the request for service RQ originates. To that end, the delivery facility DLV may receive the user identification UID from the request handling facility RQH. The return message RM signals the user that the content-augmented representation CA is ready. The return message RM may comprise the content-augmented representation CA. The return message RM may also comprise a link to the content-augmented representation CA. For example, the content-augmented representation CA may be stored in the database DB of the service center SC once the content augmentation processor AUGP has generated the content-augmented representation CA. The link, which is present in the return message RM, specifies an address within the database DB under which the content-augmented representation CA is stored.

The return message RM, or a similar message, may also be sent to other users whose recording content was present in the fine selection of personal recording records FSRR. That is, the return message RM may also be sent to all those users who have contributed to the content-augmented representation CA. Such a service will incite users to submit personal recordings to the service center SC.

### Concluding Remarks

The detailed description hereinbefore with reference to the drawings is merely an illustration of the invention and the additional features, which are defined in the claims. The invention can be implemented in numerous different manners. In order to illustrate this, some alternatives are briefly indicated.

There are numerous different manners to implement a service center for personal recordings in accordance with the invention. The service center for personal recordings illustrated in FIG. 2 is merely an example. This service center comprises various functional entities. One or more of these functional entities may reside in one server, whereas one or more other functional entities may reside in another server. That is, the functional entities that constitute the service center may be distributed throughout a network. A service center need not systematically store a personal recording in the database. A user may submit a personal recording merely for the purpose of obtaining a content-augmented version of the personal recording, without requiring any database storage of this personal.

A service center for personal recordings may comprise an encryption-and-decryption facility in order to establish secure communications with users. A user may wish to safeguard privacy and security of some or all of his or her personal recordings. For example, a personal recording may concern a private event, which is intended for a relatively small circle of persons only. Apart from submitting such a personal recording to the service center in a secure fashion, the user may also want to restrict the use of the personal recording within the service center. To that end, the service center may comprise an access management facility that selectively allows the personal recording to be used for the purpose of, for example, content augmentation. This facility may check whether a service, which involves using the personal recording, is requested by someone who is part of the small circle of persons with whom the user wishes to exclusively share the personal recording, or not. If not, the access management facility may prevent the personal recording from being used.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of content augmentation comprising:
a personal recording collection step (S1-S7) in which a service center (SC) collects personal recordings (P1, P2, P3) from various different users (A, B, C) via a network (NW) so as to constitute a database (DB) of personal recordings;
a selection step (S8-S9) in which the service center identifies personal recordings within the database that concern a particular scene and that are mutually complementary so as to form a selection of personal recordings (FSRR) for content augmentation purposes; and
a content augmentation step (S10) in which the service center applies a content augmentation process (AUGP) to the selection of personal recordings so as to obtain an enhanced representation (CA).

2. A method of content augmentation as claimed in claim 1, comprising:
an association step (S6) in which the service center (SC) associates metadata (MDS) with a personal recording that is collected, the metadata (MDS) describing content (CR) of the personal recording;
the selection step (S8-S9) involving a comparison of metadata that is associated with a personal recordings with metadata that is associated with another personal recording.

3. A method of content augmentation as claimed in claim 2, comprising:
a metadata generation step (S3) in which the service center (SC) generates supplementary metadata (MDX) on the basis of metadata (MD) that is received in association with a personal recording.

4. A method of content augmentation as claimed in claim 3, in which the metadata generation step (S3) involves interrogating an auxiliary database (XDB) on the basis of the metadata (MD) that is received in association with the personal recording.

5. A method of content augmentation as claimed in claim 2, comprising:
a metadata request step in which the service center (SC) transmits a query message to a device (MP1, MP2, MP3) from which a personal recording has been submitted to the service center, the query message causing the device to prompt a user (A, B, C) of the device to specify metadata.

6. A method of content augmentation as claimed in claim 1, comprising:
a personal recording management step in which the service center (SC) manages respective collections of personal recordings, each of which belongs to a particular user (A, B, C), the respective collections of personal recordings being stored in the database (DB), the selection step (S8-S9) involving various collections belonging to various different users.

7. A service center (SC) arranged to collect personal recordings (P1, P2, P3) from various different users (A, B, C) via a network (NW) so as to constitute a database (DB) of personal recordings; the service center comprising:
a selection facility (CSEL, FSEL) for identifying personal recordings within the database that concern a particular scene and that are mutually complementary so as to form a selection of personal recordings (FSRR) for content augmentation purposes; and
a content augmentation processor (AUGP) for applying a content augmentation process to the selection of personal recordings so as to obtain an enhanced representation (CA).

8. A computer program product for a programmable processor, the computer program product comprising a set of instructions that, when loaded into the programmable processor, causes the programmable processor to carry out the method according to claim 1.
